(19) United States
(12) Patent Application Publication
(10) Pub. No.: US 2011/0296086 A1
(43) Pub. Date: Dec. 1, 2011

(54) FLASH MEMORY HAVING TEST MODE FUNCTION AND CONNECTION TEST METHOD FOR FLASH MEMORY

(75) Inventor: Masahiro SAITOU, Kawasaki (JP)

(73) Assignee: FUJITSU LIMITED, Kawasaki-shi (JP)

(21) Appl. No.: 13/112,256

(22) Filed: May 20, 2011

(30) Foreign Application Priority Data
May 25, 2010 (JP) 2010-119678

(51) Int. Cl. G06F 12/02

(52) U.S. Cl. 711/103; 711/E12.008

(57) ABSTRACT

A flash memory including a controller, the controller including: a state machine; a state decoder that determines whether a state of the state machine is in a specified mode; a command decoder that determines whether an input signal received through an external pin specifies a write operation for writing a specific value into a specific address; and a test mode setting circuit that sets a test mode while the specified mode is maintained when the state decoder determines that the state of the state machine is in the specified mode and when the command decoder determines that the input signal received through the external pin specifies a write operation for writing a specific value into a specific address.

### CROSS-REFERENCE TO RELATED APPLICATIONS

This application is based upon and claims the benefit of priority of the prior Japanese Patent Application No. 2010-119678, filed on May 25, 2010, the entire contents of which are incorporated herein by reference.

### FIELD

The embodiments discussed herein relate to a flash memory having a test mode function and a connection test method for the flash memory.

### BACKGROUND

In mass-storage flash memory devices, the number of address lines is greater than the number of data lines. When constructing a system in which a flash memory is mounted on a board, a connection test between the flash memory and peripheral circuits thereof is performed. In this case, when using a common interface memory, since the higher bits of address lines are 0 or the don't care state, connection tests are not basically performed. For checking the higher bits of address lines, the following connection test may be conducted. A test pattern is written into a data array in the flash memory while changing the values of the address lines, and after that, the output is read out to determine whether the test pattern and the output coincide with each other. However, this type of connection test is time-consuming.

An example of semiconductor storage devices of the related art is known (for example, Japanese Laid-open Patent Publication No. 58-121188A). The following function has been added to this semiconductor storage device. A signal path through which a certain input signal is directly output as an output signal is provided, and the semiconductor storage device is regarded as a mere signal selection circuit. With this function, a connection test for the semiconductor storage device with peripheral circuits is facilitated.

Another example of semiconductor storage devices of the related art having the following test function is also known (for example, Japanese Laid-open Patent Publication No. 2003-86000A). In this example, a specific command input through a data input/output terminal is identified, and data input through an address input terminal is compared with expected value data stored in a storage unit.

With the increasing storage capacity of flash memory devices, it is difficult to properly perform a test, for example, a connection test for the higher bits of address lines, after a flash memory is mounted on a board. Also, there is a demand that a connection test for a flash memory be performed while maintaining pin compatibility with standard devices or without changing standard specifications.

### SUMMARY

According to an aspect of the invention, a flash memory includes a controller, the controller including: a state machine; a state decoder that determines whether a state of the state machine is in a specified mode; a command decoder that determines whether an input signal received through an external pin specifies a write operation for writing a specific value into a specific address; and a test mode setting circuit that sets a test mode while the specified mode is maintained when the state decoder determines that the state of the state machine is in the specified mode and when the command decoder determines that the input signal received through the external pin specifies a write operation for writing a specific value into a specific address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a system block diagram illustrating an example of a connection test.

FIG. 2 illustrates a control process method in a common flash memory interface (CFI) query mode.

FIG. 3 illustrates the internal configuration of a standard flash memory.

FIG. 4 illustrates the internal configuration of a flash memory according to first through third embodiments.

FIG. 5 illustrates an overview of a control process method for starting a test mode while maintaining the CFI query mode according to the first embodiment.

FIG. 6 illustrates a controller used in the flash memory according to the first embodiment.

FIG. 7 illustrates selection circuits used in the flash memory according to the first embodiment.

FIG. 8 is a timing chart illustrating operations performed by the controller and the selection circuits during the test mode according to the first embodiment.

FIG. 9 illustrates an overview of a control process (a plurality of test modes) method for starting the test mode while maintaining the CFI query mode according to the second embodiment.

FIG. 10 illustrates a controller used in the flash memory according to the second embodiment.

FIG. 11 illustrates a first configuration of the selection circuits used in the flash memory according to the second embodiment.

FIG. 12 illustrates a second configuration of the selection circuits used in the flash memory according to the second embodiment.

FIG. 13 illustrates a controller used in the flash memory according to the third embodiment.

FIG. 14 illustrates the internal configuration of a flash memory according to a fourth embodiment.

### DESCRIPTION OF EMBODIMENTS

A detailed description of embodiments is given below with reference to the drawings.

Checking the connection between devices mounted on a printed circuit board may be performed by the use of a boundary scan method. Alternatively, the devices may be actually operated to check the connection therebetween.

To use the boundary scan method, each device supports the boundary scan method. Some devices do not have terminals for the boundary scan method, in which case, the devices are actually operated to perform a connection test.

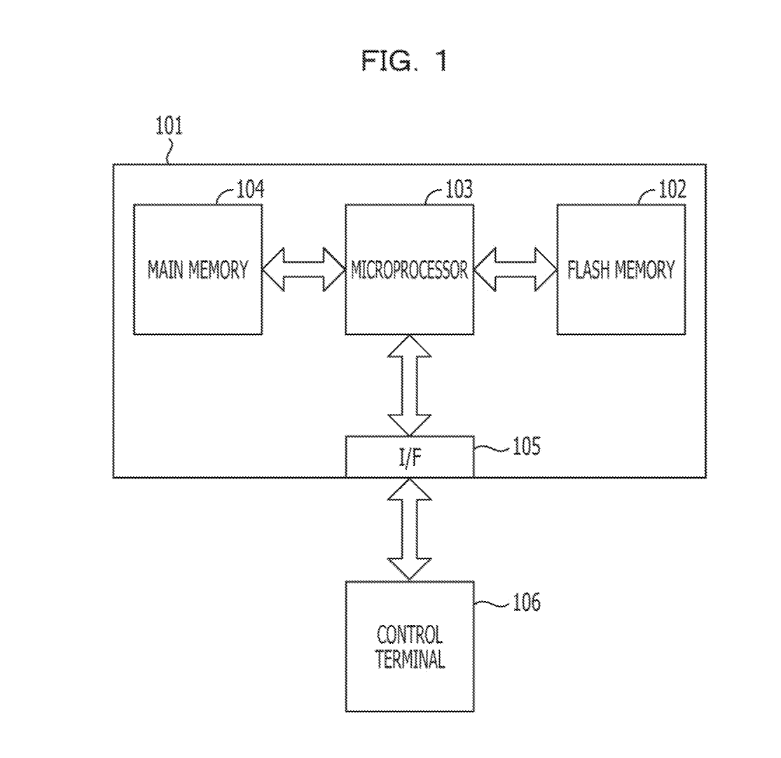

In a board on which a microprocessor and a work memory are mounted, software for a connection test is run on the microprocessor to perform the connection test. This type of test may be employed in, for example, a motherboard used in a personal computer or a control board mounted on a high-reliability switch router. For example, on a control board 101, as illustrated in FIG. 1, a flash memory 102, a microprocessor 103, a main memory 104, and an interface circuit (I/F) 105 are mounted. In this case, when testing the connection between the flash memory 102 and the microprocessor 103, a control terminal 106 may be connected to the interface circuit 105 so that the microprocessor 103 controls the device of the flash memory 102 via the control terminal 106. By executing a test operation properly between the flash memory 102 and the microprocessor 103, a test pattern signal may be supplied from the microprocessor 103 to the flash memory 102. By using this method, the provision of a wiring area for the boundary scan method on the control board 101 is made unnecessary.

In standard flash memory devices, a standard interface agreed upon between vendors, which is referred to as the “common flash memory interface (CFI)”, is implemented.

In a CFI-implemented flash memory, when a specific address or data is written into the flash memory from an external source, the state of the flash memory shifts to a CFI query mode, which is defined by the CFI. In this mode, when a read command that specifies a certain address is input into the flash memory from an external source so as to perform a read operation, various types of data representing the features of the flash memory, such data being referred to as the “CFI information”, are output from the flash memory. The CFI information represents known values that are inherent to the flash memory. Thus, by checking whether the known inherent values are read as expected, testing of the connection between the flash memory and the microprocessor may be conducted.

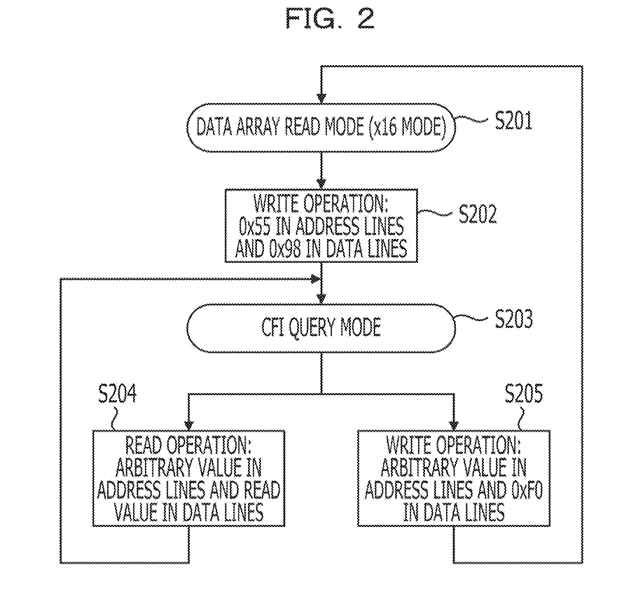

This will be more specifically described with reference to the operations illustrated in FIG. 2. It is now assumed that the flash memory is operated in a data array read mode, which is a normal mode for performing a read operation from a built-in data array (operation S201). In this state, address 0x55 and data 0x98 are written into the flash memory (operation S202). Then, the state of the flash memory shifts to the CFI query mode defined by the CFI (operation S203). In this mode, a read command that specifies a certain address is input into the flash memory from an external source so as to perform a read operation (operation S204). As a result, various types of data representing the features of the flash memory (such data is referred to as the “CFI information”) are output from the flash memory (repeating operations S203→S204→S203). The CFI information represents known values that are inherent to the flash memory. Thus, by checking whether the known inherent values are read as expected, testing of the connection between the flash memory and the microprocessor may be conducted. In the CFI query mode, an arbitrary address and a reset command indicating data 0xF0 are input into the flash memory from an external source so that the state of the flash memory returns to the data array read mode (operations S203→S205→S201).

The address lines, data lines, and control lines (i.e., signal lines for read/write signals, chip select signals, and output enable signals) are checked for faults using the above-described sequence for reading the CFI information. If the connection between the flash memory and the microprocessor is not correct, the values inherent to the flash memory are not read as expected, in which case, it is decided that a device fault or a connection fault has occurred.

However, in the read operation for the CFI information in the CFI query mode, it is not possible to check the connection for the higher bits of address lines of a mass-storage flash memory. This is because, in this method, the higher bits of address lines, for example, the higher 16 bits, are set to be 0 or the don't care state. Accordingly, even if, for example, 0 is incorrectly set in the higher bits of address lines, the read operation for device information is correctly performed. Thus, it is not possible to check for faults of the flash memory. If the auto select mode provided for the flash memory is used, the number of address lines that are checked is increased. However, the connection for the higher bits of address lines, which are set to be 0 or the don't care state, are not still checked.

Accordingly, concerning the higher bits of address lines, which are not subjected to the connection test in the CFI query mode, a test pattern is written into the data array in the flash memory, and is read. This method is, however, time-consuming.

That is, in flash memory devices that are being widely used, when writing data into a data array for conducting a device test, a certain area (referred to as a “sector”) of the data array, for example, an area into which the data is written, is cleared because of the device characteristics. Additionally, if information concerning the shipping of a flash memory as a finished product has been written into the flash memory by a read only memory (ROM) writer, the following procedure is to be taken. The written data is temporarily saved before performing a connection test on the flash memory mounted on a board, and after completing the connection test, the stored data is rewritten into the original area. As the area in which the written data is saved, a high-speed device, such as a static read access memory (SRAM), mounted on the same board may be used.

In the known test method that requires writing of data into a data array, preprocessing (saving of written data and clearing of sectors) and postprocessing (clearing of sectors and rewriting of the saved data) are necessary, which is considerably time-consuming.

If a test method that does not require writing of data into a data array is employed, the above-described problem may be solved.

There is a plurality of hardware configurations for a flash memory that make it possible to achieve faster testing. No matter which hardware configuration is used, a mechanism for controlling the flash memory to perform a test operation is used. The mechanism determines whether to perform a normal operation or a test operation. The state in which the flash memory performs a test operation is hereinafter referred to as the “test mode”.

If an external control pin for changing the state of the flash memory to the test mode is provided, the pin compatibility with known devices is not maintained. Pin non-compatible devices cannot be mounted on a printed circuit board designed for mounting known devices thereon. This makes it necessary to redesign circuits including peripheral circuits.

Devices supporting the boundary scan method, which is a standard method, have a higher versatility than devices having special-use external pins, and are thus more easily put on the market.

It is desirable that devices that do not support the boundary scan method have a mechanism for changing the state of the devices to the test mode without using external pins.

Without the use of external pins, CFI specifications may be independently extended by vendors, and by inputting a command sequence, the state of the flash memory devices may be shifted to the test mode.

However, if the feature extension of the standardized interface is performed independently by the vendors, the extended features may be impaired when changes are made to the standard specifications in the future. For example, if an unused code is assigned to the interface in the current standard specifications, another meaning may be assigned to the interface when changes are made to the standard specifications later.

It is thus desirable that interfaces that are not vulnerable to future changes to the common specifications be defined.

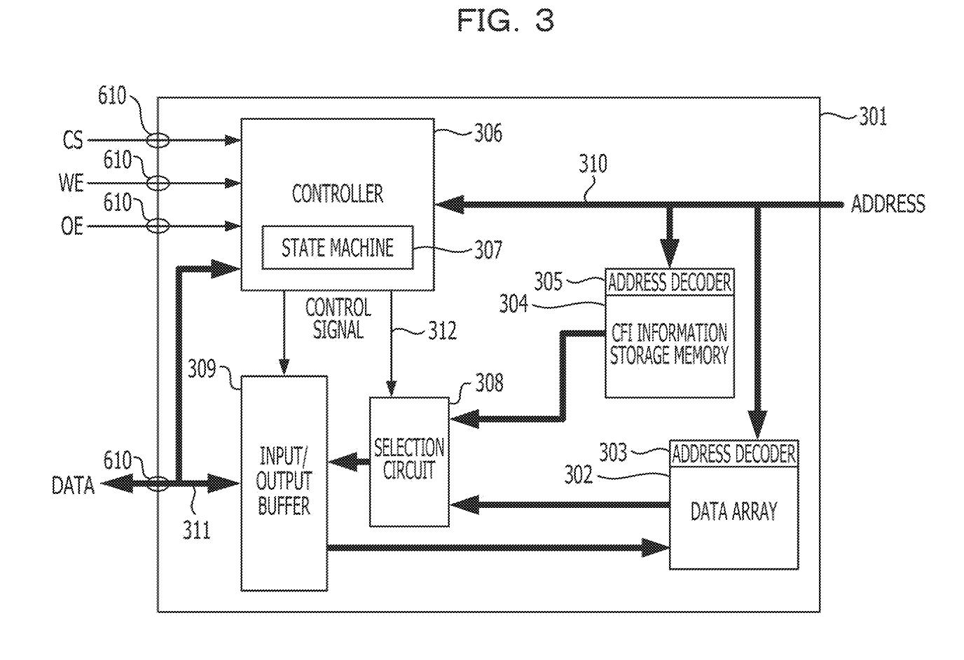

FIG. 3 is a block diagram illustrating the internal configuration of a standard flash memory 301. Details of the elements of the standard flash memory 301 are given below. A data array 302 stores data therein. An address decoder 303 is connected to the data array 302, and decodes an address specified from an external source via an address line set 310 so as to specify an address in the data array 302. A CFI information storage memory 304 stores CFI information therein. An address decoder 305 is connected to the CFI information storage memory 304, and decodes an address specified from an external source via the address line set 310 so as to specify an address in the CFI information storage memory 304. A controller 306 supplies a control signal 312 to a selection circuit 308 and an input/output buffer 309 on the basis of a chip select signal CS, a write enable signal WE, and an output enable signal OE supplied from an external source through an external pin 610. The controller 306 is formed of a logic circuit and contains a state machine 307 that controls the state of the flash memory 301. The selection circuit 308 selects an output from the data array 302 or an output from the CFI information storage memory 304 on the basis of the control signal 312 supplied from the controller 306. When reading data, the input/output buffer 309 receives and buffers data or CFI information output from the selection circuit 308, and outputs the data or the CFI information to an external source via a data line set 311 and the external pin 610. When writing data, the input/output buffer 309 buffers data input from an external source via the data line set 311, and writes the buffered data to the data array 302.

The standard flash memory 301 illustrated in FIG. 3 is controlled in accordance with the operations illustrated in FIG. 2. After starting the standard flash memory 301, the state machine 307 operates in the data array read mode for performing reading from the data array 302 (operation S201 in FIG. 2).

In this state, a chip select signal CS (enable) and a write enable signal WE (enable, i.e., specify a write operation) are input from an external source, and address 0x55 and data 0x98 are input into the address line set 310 and the data line set 311, respectively (operation S202 in FIG. 2). As a result, the controller 306 decodes the above-described signals so that the state of the state machine 307 shifts to the CFI query mode (S203 in FIG. 2).

In the CFI query mode, an address used in the query mode is input into the address line set 310 from an external source, and also, a chip select signal CS (enable), a write enable signal WE (disable, i.e., specify a read operation), and an output enable signal OE (enable) are input. As a result, the address decoder 305 decodes the address and supplies the decoded address to the CFI information storage memory 304. The controller 306 supplies the selection signal 312 for selecting the output from the CFI information storage memory 304 to the selection circuit 308. As a result, CFI information read from the CFI information storage memory 304 corresponding to the specified address is output to an external source from the selection circuit 308 via the input/output buffer 309 and the data line set 311 (operation S204 in FIG. 2).

In this case, since the storage capacity of the CFI information storage memory 304 is limited, the effective address of the address line set 310 having, for example, 25 bits, is the lower 16 bits, and the higher 9 bits are set to be 0 or the don't care state.

With the above-described operation, by checking whether the expected CFI information is read from the data line set 311, a connection test concerning specifying an address by using the lower 16 bits is conducted.

In the CFI query mode, a chip select signal CS (enable) and a write enable signal WE (enable, i.e., specify a write operation) are supplied from an external source, and data 0xF0 is supplied to the data line set 311 (operation S205 in FIG. 2). The address supplied to the address line set 310 may be an arbitrary value. As a result, the controller 306 decodes the above-described signals so that the state of the state machine 307 is returned to the data array read mode (operations S203→S205→S201 in FIG. 2). In the data array read mode, the controller 306 supplies the selection signal 312 for selecting the output from the data array 302 to the selection circuit 308.

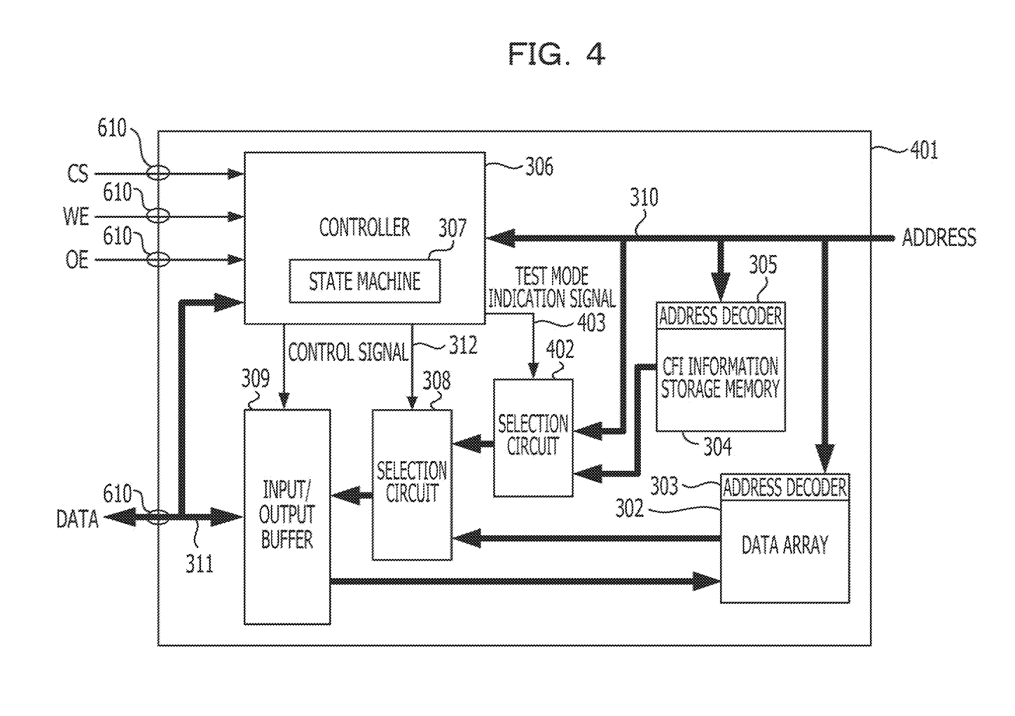

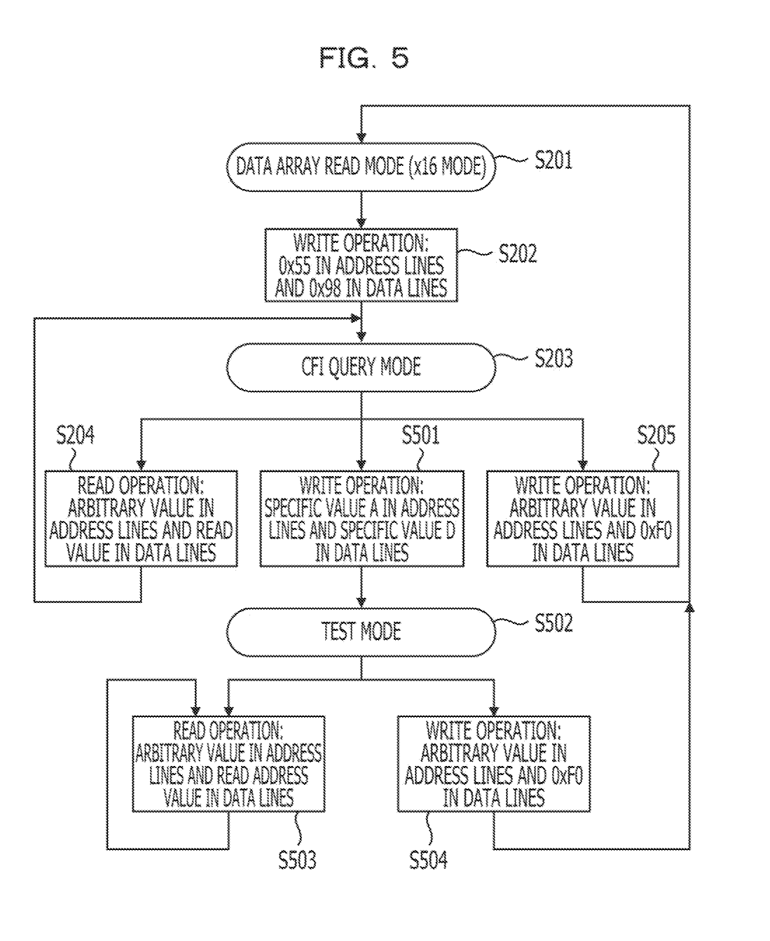

FIG. 4 is a block diagram illustrating the internal configuration of a flash memory 401 according to first through third embodiments, which are discussed below. In FIG. 4, the same elements as illustrated in FIG. 3 are indicated by like reference numerals. The flash memory 401 includes a selection circuit 402 in addition to the elements illustrated in FIG. 3. The selection circuit 402 is disposed between the CFI information storage memory 304 and the selection circuit 308. The selection circuit 402 selects an output from the CFI information storage memory 304 or higher addresses of the address line set 310 and supplies the selected data to the selection circuit 308. The selection circuit 402 is controlled by a test mode indication signal 403, which indicates the test mode, supplied from the controller 306. The test mode is a mode in which a connection test for the address line set 310, particularly for higher bits of the address line set 310, is conducted while the CFI query mode is maintained, as described below with reference to FIG. 5.

FIG. 5 illustrates operations giving an overview of a control process for starting the test mode while maintaining the CFI query mode in the flash memory 401 illustrated in FIG. 4 in accordance with the first embodiment. In FIG. 5, the substantially same operations as illustrated in FIG. 2 are designated by the same operation numbers.

In FIG. 5, the operation for shifting the state of the flash memory 401 from the data array read mode to the CFI query mode in response to address 0x55 and data 0x98 (specify a write operation) is substantially similar to that illustrated in FIG. 2. The operation for reading CFI information by specifying an arbitrary address is substantially similar to that illustrated in FIG. 2. The operation for shifting the state of the flash memory 401 from the CFI query mode to the data array read mode by inputting data 0xF0 and by specifying an arbitrary address is substantially similar to that illustrated in FIG. 2.

In the CFI query mode, a chip select signal CS (enable) and a write enable signal (enable, i.e., specify a write operation) are supplied from an external source to the flash memory 401 illustrated in FIG. 4. Also, data indicating a specific value D and an address indicating a specific value A are supplied from an external source to the data line set 311 and the address line set 310, respectively. In this manner, in the CFI query mode, the write operation for writing the address (specific value A) and the data (specific value D), which are not specified by the CFI, is specified. As the data (specific value D), a data value, which is other than 0xF0 representing the reset command, is specified. As a result, the controller 306 decodes the above-described signals so as to supply the test mode indication signal 403 indicating the test mode to the selection circuit 402. The state of the flash memory 401 is then changed to the test mode while the state of the state machine 307 is maintained in the CFI query mode. The control processing described above is composed of the operation flow S203→S501→S502 in FIG. 5.

During the above-described test mode, the CFI query mode is also maintained. Accordingly, if a read operation, which is normally performed in the CFI query mode, is specified during the test mode, the following operation is executed. An address for testing is supplied from an external source to the address line set 310, and a chip select signal CS (enable), a write enable signal WE (disable, i.e., specify a read operation), and an output enable signal OE (enable) are supplied. Then, in a manner substantially similar to the flash memory 301 illustrated in FIG. 3, the controller 306 supplies the control signal 312 for selecting the input, which is not the input received from the data array 302, to the selection circuit 308. As a result, in this embodiment, the output from the selection circuit 402 is selected as the input of the selection circuit 308. In this case, in the test mode, the selection circuit 402 selects a specific range of address values (for example, higher bits) of the address line set 310. As a result, the specific range (for example, higher bits) of the address line set 310 is output through the selection circuit 402 and the selection circuit 308 to an external source via the input/output buffer 309 and the data line set 311. The process described above is composed of the operation flow S502→S503 in FIG. 5.

With the above-described read operation, in the test mode while the CFI query mode is maintained, it is possible to check whether the address values of a specific range of the address line set 310 are read through the data line set 311. As a result, a connection test to determine whether the address values of the specific range (for example, higher bits) of the address line set 310 are correctly specified is conducted.

In this embodiment, the test mode is maintained during the CFI query mode as long as the read operation is specified. Thus, the connection test for the address values of a specific range (for example, higher bits) of the address line set 310 can be continued.

In the test mode while the CFI query mode is being maintained, a chip select signal CS (enable) and a write enable signal WE (enable, i.e., specify a write operation) are supplied from an external source, and also, data 0xF0 is supplied to the data line set 311 (operation S504 in FIG. 5). The address supplied to the address line set 310 may be an arbitrary value. As a result, the controller 306 decodes the above-described signals so that the state of the state machine 307 returns to the data array read mode, in a manner similar to operation S205 in FIG. 5. The processing described above is composed of the operation flow S502→S504→S201 in FIG. 5.

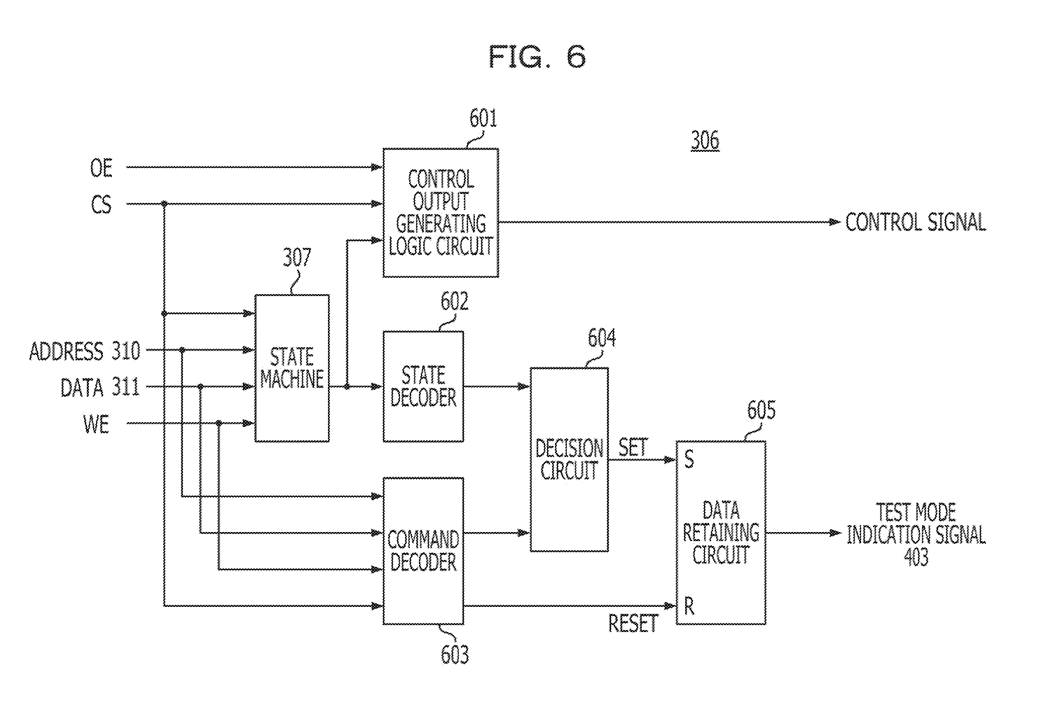

FIG. 6 is a block diagram illustrating the controller 306 of the flash memory 401 configured as illustrated in FIG. 4 according to the first embodiment. In FIG. 6, the substantially same elements as illustrated in FIG. 4 are designated by like reference numerals. The controller 306 configured illustrated in FIG. 6 executes the control process shown by the operations illustrated in FIG. 5.

The state machine 307 and a control output generating logic circuit 601 illustrated in FIG. 6 are basically the same as those used in a standard flash memory. That is, the content of a control signal output from the controller 306 is basically the same as that of a standard flash memory.

The blocks other than the state machine 307 and the control output generating logic circuit 601 are used for changing the mode to the test mode and for notifying an external source that the state of the flash memory 401 is in the test mode.

A state decoder 602 determines whether the state of the state machine 307 is in the CFI query mode. When the state of the state machine 307 is in the CFI query mode, the state decoder 306 supplies a logical value “true” to a decision circuit 604, which is disposed subsequent to the state decoder 602. When the state of the state machine 307 is not in the CFI query mode, the state decoder 306 outputs a logical value “false” to the decision circuit 604.

When inputs from an external source are as follows: the chip select signal CS indicates “true”, the write enable signal WE indicates “true”, the address on the address line set 310 represents a specific value, and the data on the data line set 311 represents a specific value, a command decoder 603 outputs a logical value “true” to the decision circuit 604. When inputs from an external source are other than those of the case described above, the command decoder 603 outputs a logical value “false” to the decision circuit 604. When the test mode is selected, a data retaining circuit 605 outputs a logical value “true” as the test mode indication signal 403 (see FIG. 4). When the test mode is not selected, the data retaining circuit 605 outputs a logical value “false” as the test mode indication signal 403. When the input from the state decoder 602 indicates “true” and when the input from the command decoder 603 indicates “true”, the decision circuit 604 outputs a set signal S for instructing the data retaining circuit 605 to set the test mode to the data retaining circuit 605. That is, when there is a demand for writing specific data into a specific address from an external source during the CFI query mode, the data retaining circuit 605 sets the test mode. As a result, control processing for operations S501→S502 is implemented.

When a signal for changing the mode to the test mode is input during the test mode, the test mode is also set. That is, the state of the flash memory 401 remains the same.

When inputs from an external source are as follows: the chip select signal CS indicates “true”, the write enable signal WE indicates “true”, the address on the address line set 310 represents an arbitrary value, and the data on the data line set 311 represents a reset code, the command decoder 603 also outputs a logical value “true”. This output is supplied to the data retaining circuit 605 as a reset signal R for setting the non-test mode. With this arrangement, when a reset code is written from an external source, the data retaining circuit 605 is set in the non-test mode regardless of the state of the state machine 307. In this case, the state of the state machine 307 is changed to the data array read mode in accordance with the operation of a standard flash memory in response to a reset request. As a result, control processing for operation S504 illustrated in FIG. 5 is implemented.

The output from the data retaining circuit 605 is supplied external to the controller 306 as the test mode indication signal 403. Upon receiving the test mode indication signal 403, the selection circuit 402 illustrated in FIG. 4 can identify whether the test mode indication signal 403 indicates the test mode or the non-test mode.

In the controller 306 configured as illustrated in FIG. 6, once the test mode is set, it is maintained unless a reset code is input. With this arrangement, if operations in the test mode are to be continuously performed a plurality of times while changing a test pattern, inputting of a sequence for changing the state of the flash memory 401 to the test mode from an external source is performed.

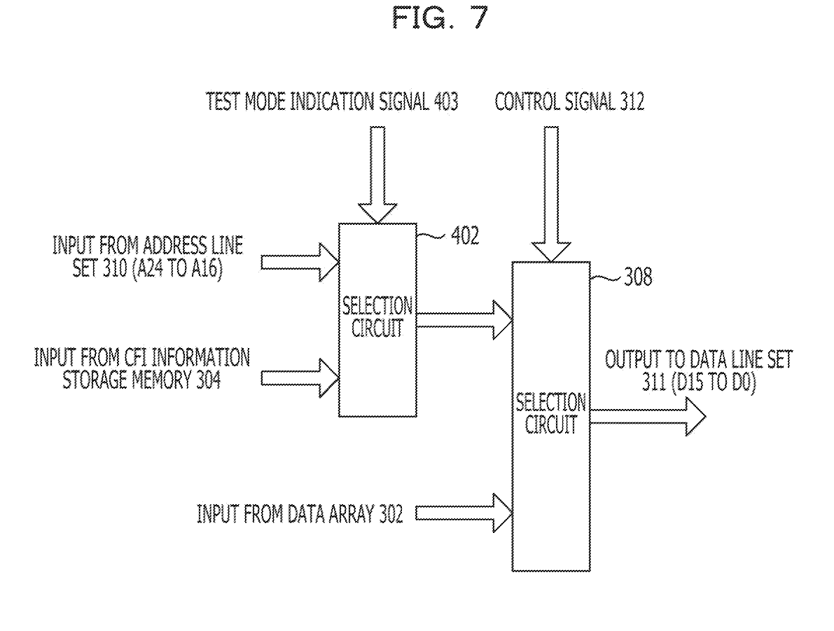

FIG. 7 is a block diagram illustrating the selection circuits 402 and 308 illustrated in FIG. 4 according to the first embodiment. In FIG. 7, the substantially same elements as illustrated in FIG. 4 are designated by like reference numerals.

In mass-storage flash memory devices, the number of address lines is greater than the number of data lines. For example, if a device has a capacity of 512 megabits and performs access with a 16-bit width, the number of address lines is 25. The address lines forming the address line set 310 illustrated in FIG. 4 are indicated by A24 through A0, while the data lines forming the data line set 311 illustrated in FIG. 4 are designated by D15 through D0.

The higher address lines A24 through A16 are connected to an input of the selection circuit 402. In the test mode, in response to the test mode indication signal 403, the controller 306 illustrated in FIG. 6 controls the output from the selection circuit 402 to be supplied to the input to which the higher address lines A24 through A16 are connected. In response to the control signal 312 from the controller 306, the selection circuit 308, which is disposed subsequent to the selection circuit 402, determines the input to be supplied to each of the data lines D15 through DO forming the data line set 311. When the state of the state machine 307 illustrated in FIG. 6 indicates the CFI query mode, in response to a read request command from an external source, the controller 306 outputs the control signal 312 to control the selection circuit 308 in the following manner. In response to the control signal 312, the selection circuit 308 outputs the input, which is not the input received from the data array 302, to the data line set 311 via the input/output buffer 309. With this operation, the address values of the higher address lines A24 through A16 forming the address line set 310 are output from the selection circuit 402 and the selection circuit 308 to an external source via the input/output buffer 309 and the data line set 311. As a result, control processing for operation S503 illustrated in FIG. 5 is implemented.

Details of the test procedures are given below. Procedure 1 is as follows. A write operation for changing the mode from the data array read mode to the CFI query mode is specified. In this case, an arbitrary value is set in the address lines A24 through A16, 0x55 is set in the address lines A15 through A0, 0x98 is set in the data lines D15 through D0, and a chip select signal CS (enable) and a write enable signal WE (enable) are input. This operation corresponds to operations S201→S202→S203 in FIG. 5. After that, as a test for the lower 16 bits (address lines A15 through A0) forming the address line set 310, CFI information is read from the CFI information storage memory 304 (see FIG. 4) in the CFI query mode. This operation corresponds to repeated operations S203→S204→S203 in FIG. 5.

Procedure 2 is as follows. After the test has been successfully completed in procedure 1, a write operation for setting the test mode while maintaining the CFI query mode is specified. In this case, an arbitrary value is set in the address lines A24 through A16, the specific value A is set in the address lines A15 through A0, the specific value D is set in the data lines D15 through D0, and a chip select signal CS (enable) and a write enable signal WE (enable) are input. Procedure 2 corresponds to operations S203→S501→S502 in FIG. 5.

Procedure 3 is as follows. From an external source, a test pattern is input into the address lines A24 through A16, an arbitrary value is set in the address lines A15 through A0, and a chip select signal (enable) and a write enable signal WE (disable) are input.

Procedure 4 is as follows. The values appearing in the data lines D8 through D0 are checked when the output enable signal OE indicates “enable” coincide with the values of the test pattern input into the address lines A24 through A16 in procedure 3. The data lines D15 through D9 are in the don't care state.

Procedure 5 is as follows. Since the state of the flash memory 401 remains in the test mode during the transfer test, by changing the test pattern for the address lines A24 through A16 a required number of times, procedures 3 and 4 are repeated. For example, the values assigned to the address lines are changed bit by bit. Procedures 3, 4, and 5 correspond to repeated operations S503→S502→S503 in FIG. 5.

Procedure 6 is as follows. If the check results in procedure 4 are always as expected, it is determined that the connection of the address line set 310 (see FIG. 4) is correct.

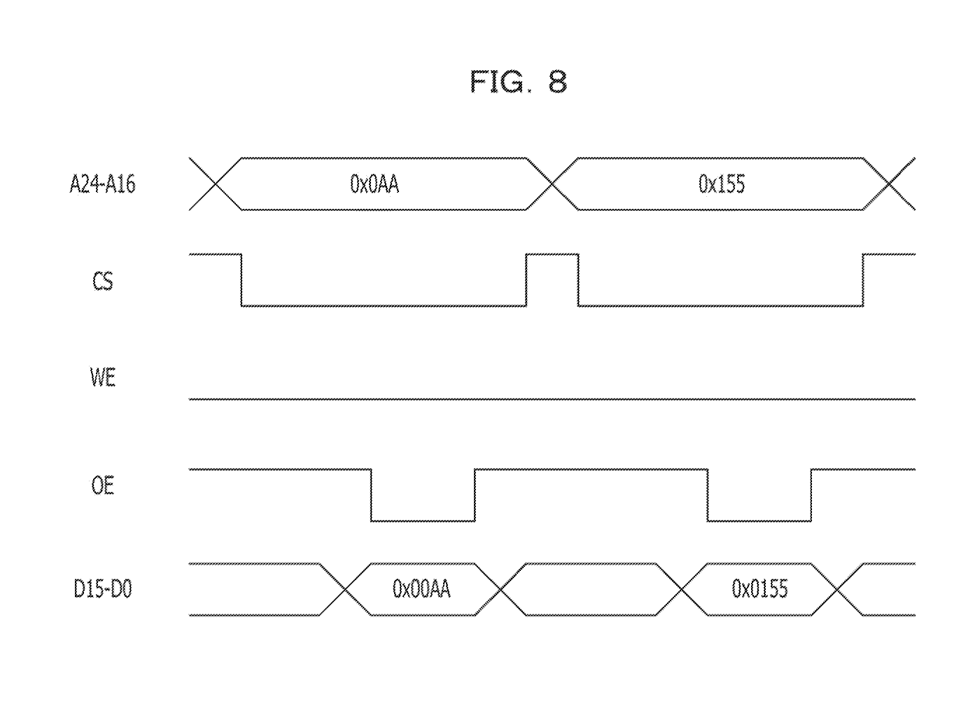

FIG. 8 is a timing chart illustrating operations performed by the controller 306 illustrated in FIG. 6 and the selection circuits 402 and 308 illustrated in FIG. 7 during the test mode.

In procedures 3 through 5, the test pattern 0x0AA and 0x155 (arrangements of “0”s and “1”s are displaced) is used for the test for the address lines A24 through A16, as indicated by A24-A16 of FIG. 8. During the addressing period, the chip select signal CS (see CS of FIG. 8) is enabled, while the write enable signal WE (see WE of FIG. 8) is disabled. The data appearing in the data lines D8 through D0 at a time at which the output enable signal OE (see OE of FIG. 8) becomes enabled are the values returned from the address lines A24 through A16.

According to the first embodiment illustrated in FIGS. 4 through 8, a connection test for the higher address lines of the address line set 310 is implemented without performing clearing, writing, or reading on the data array 302. As a result, the time taken to perform the connection test can be reduced.

The test mode is started in response to a write command sequence (writing of specific value A and specific value D into the address lines and the data lines, respectively), which is not defined in the CFI query mode. That command sequence is not influenced by future changes made to the CFI specifications. Accordingly, the test mode is implemented regardless of possible changes made to the CFI specifications.

That command sequence is specified during the CFI mode, which does not require the extension of external pins, thereby maintaining versatility.

In the first embodiment, a connection test for the higher address lines is implemented without changing the configuration of the CFI information storage memory 304 having a storage capacity corresponding to the lower address lines. That is, it is not necessary to increase the storage capacity of the CFI information storage memory 304 to deal with a connection test for the higher address lines.

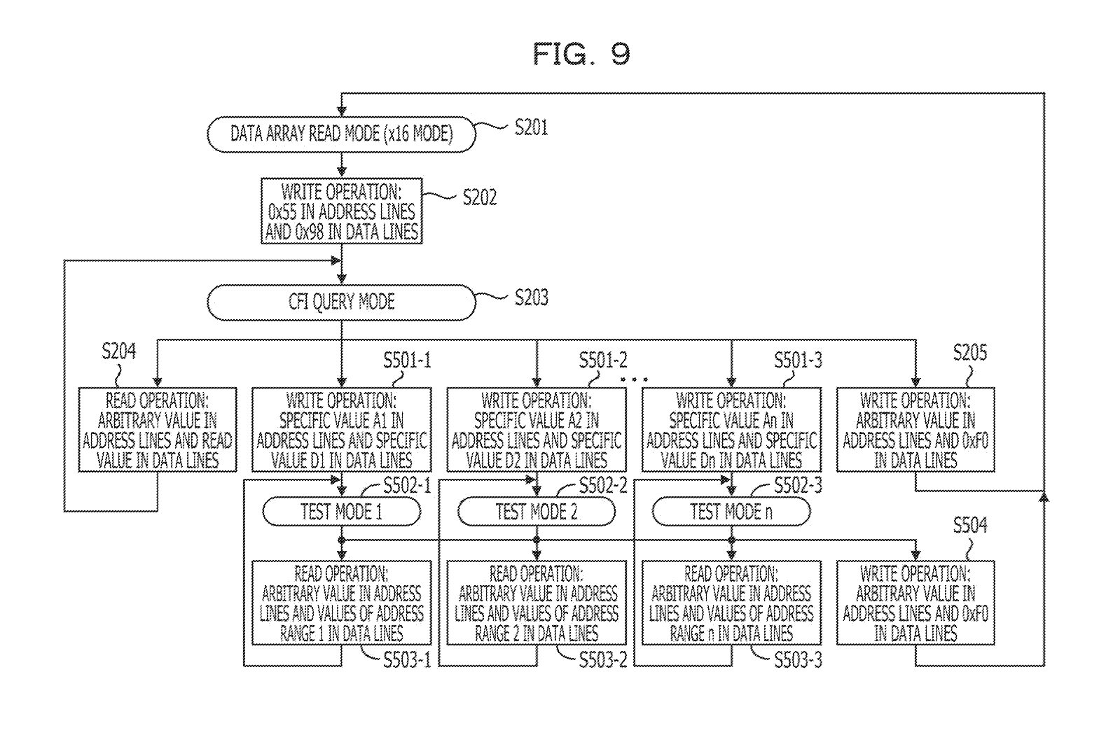

FIG. 9 illustrates operations giving an overview of a control process for starting the test mode while maintaining the CFI query mode in the flash memory 401 configured as illustrated in FIG. 4 according to the second embodiment. In FIG. 9, the substantially same operations as in FIG. 2 or 5 are designated by like operation numbers.

The control process illustrated in FIG. 9 differs from that illustrated in FIG. 5 in the following point.

In the control process illustrated in FIG. 5, in the CFI query mode, a write operation for writing one combination of the specific value A and the specific value D, which are not defined in the CFI, into the address and the data, respectively, is specified. Then, the mode is changed to the single test mode (operations S203→S501 in FIG. 5). In contrast, in the control process illustrated in FIG. 9, a plurality of combinations of address values and data values (A1, D1), (A2, D2) through (An, Dn) are set, and in response to the specified combination of address values and data values, the state of the flash memory 401 is changed to one of different test modes 1, 2, through n. The chip select signal CS (enable) and the write enable signal (enable, i.e., specify a write operation) are input, which is substantially similar to the control process in FIG. 5. In this case, the controller 306 decodes the above-described combinations of address values and data values so as to supply different test mode indication signals 403-1, 403-2, through 403-n, which are used for selecting specific ranges of address values of the address line set 310, to the selection circuit 402. After that, the flash memory 401 is shifted to one of the different test modes 1, 2, through n while the state of the state machine 307 is maintained in the CFI query mode. That is, in accordance with the above-described different combinations of address values and data values, different corresponding operations S203→S501-1→S502-1, S203→S501-2→S502-2, through S203→S501-n→S502-n illustrated in FIG. 9 are performed.

In each of the test modes 1, 2, through n, an address for testing is supplied to the address line set 310 from an external source, and a chip select signal CS (enable), a write enable signal WE (disable, i.e., specify a read operation), an output enable signal OE (enable) are supplied. Then, the controller 306 supplies the control signal 312 for selecting the input, which is not the input received from the data array 302, to the selection circuit 308. As a result, the output from the selection circuit 402 is selected as the output from the selection circuit 308. In each of the test modes 1, 2, through n, on the basis of the corresponding test mode indication signal 403 supplied from the controller 306, the selection circuit 402 selects a specific range of address values of the address line set 310 corresponding to the test mode. For example, if there are two test modes, the higher address lines and the lower address lines are selected. As a result, a specific range of address values of the address line set 310 in association with each test mode is output to the outside of the flash memory 401 from the selection circuit 402 and the selection circuit 308 via the input/output buffer 309 and the data line set 311. That is, in association with the different test modes 1, 2, through n, different corresponding operations S502-1→S503-1, S502-2→S503-2, through 5502-n→5503-n illustrated in FIG. 9 are performed.

In each test mode while maintaining the CFI query mode, by performing a reading operation for each test mode, a check of whether a specific range of address values of the address line set 310 in association with the specified test mode can be read from the data line set 311 is performed. As a result, it is possible to perform a device connection test for checking whether the address values of the specific range of the address line set 310, which is set for each test mode, are correctly specified.

In this embodiment, the test modes are continuously maintained during the CFI query mode. This makes it possible to continuously perform a connection test for the address values of a specific range for each of the specified test modes.

In each test mode while maintaining the CFI query mode, when writing of data 0xF0 for resetting the flash memory 401 is specified, the operation for changing the test mode to the data array read mode is performed, which is similar to that in FIG. 5. That is, in association with the different test modes 1, 2, through n, different corresponding operations S502-1→S504→S201, S502-2→S504→S201, through S502-n→S504→S201 illustrated in FIG. 9 are performed.

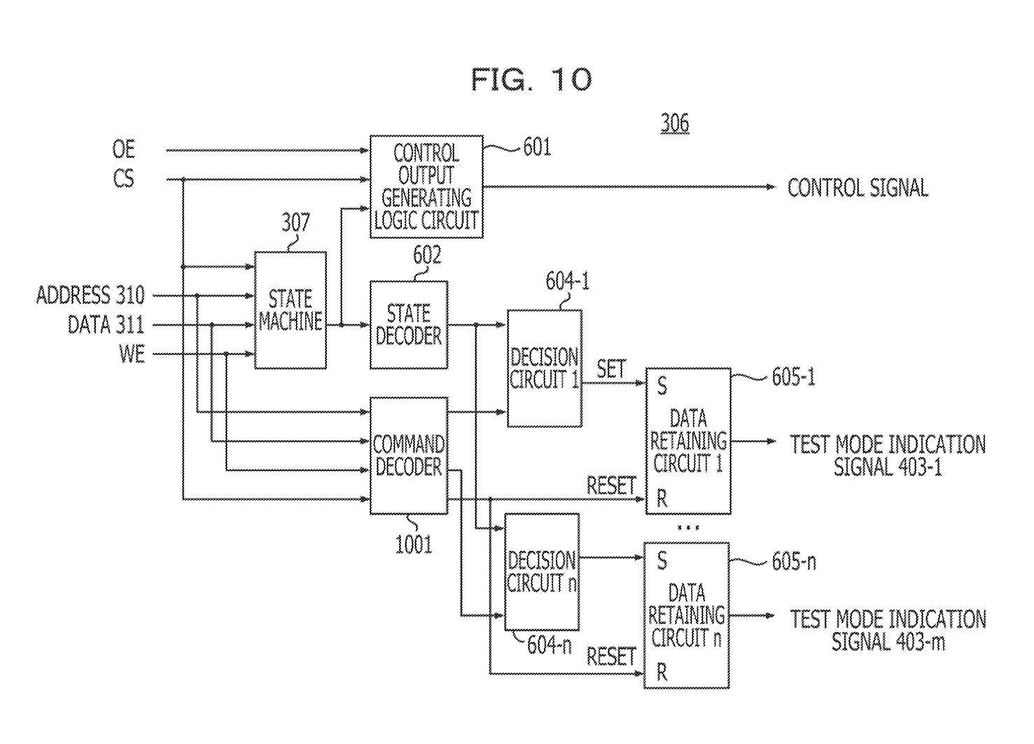

FIG. 10 is a block diagram illustrating the controller 306 used in the flash memory 401 configured as illustrated in FIG. 4 according to the second embodiment. In FIG. 10, the substantially same elements as illustrated in FIG. 4 or 6 are designated by like reference numerals. With this configuration, the control process indicated by the operations illustrated in FIG. 9 is implemented.

When a chip select signal CS indicates “true” and a write enable signal WE (enable) indicates “true” and when the combination of the address value on the address line set 310 and the data on the data line set 311 corresponds to the test mode i (i is one of 1 through n), a command decoder 1001 is operated as follows. More specifically, the command decoder 1001 supplies a logical value “true” only to a decision circuit 604-i, and supplies a logical value “false” to the other decision circuits 604. As a result, when the input from the state decoder 602 is “true” and when the input from the command decoder 1001 is “true”, the decision circuit 604-i associated with the test mode i outputs the set signal S to a data retaining circuit 605-i corresponding to the test mode i. That is, when the state machine 307 is in the CFI query mode, upon receiving a request to write a combination of the address value and the data value corresponding to the test mode i from an external source, an operation for setting the test mode i is performed. Thus, control processing for operations S203→S501-i→S502-i in FIG. 9 is implemented.

During a specified test mode, if a signal for changing to another test mode is input, the current test mode is maintained.

When inputs from an external source are as follows: the chip select signal CS indicates “true”, the write enable signal WE indicates “true”, the address on the address line set 310 represents an arbitrary value, and the data on the data line set 311 represents a reset code, the command decoder 1001 also outputs a logical value “true”. This output is supplied to all the data retaining circuits 605-1 through 605-n as a reset signal R for setting the non-test mode. With this arrangement, in any of the test modes, when a reset code is written from an external source, the data retaining circuits 605-1 through 605-n are set in the non-test mode. In this case, the state of the state machine 307 is changed to the data array read mode in a manner similar to the operation of a standard flash memory. As a result, control processing for operations S502-i→S504→S201 illustrated in FIG. 9 is implemented.

The outputs from the data retaining circuits 605-1 through 605-n in association with the different test modes 1-n are supplied to the outside of the controller 306 as the test mode indication signals 403-1 through 403-n, respectively. Upon receiving the test mode indication signals 403-1 through 403-n, the selection circuit 402 illustrated in FIG. 4 identifies whether the test mode or the non-test mode is selected and which test mode is specified.

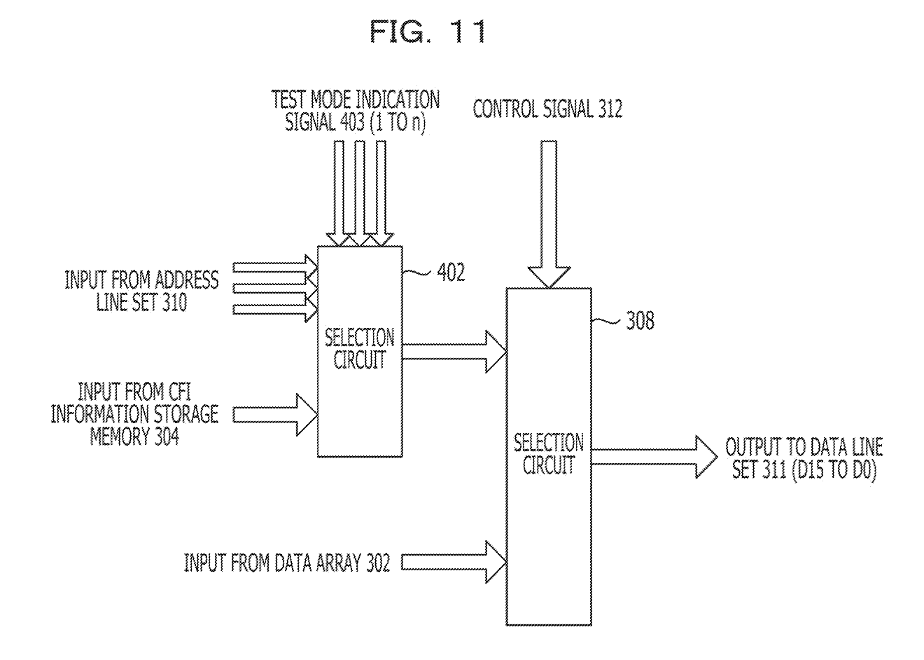

FIG. 11 is a block diagram illustrating a first configuration of the selection circuits 402 and 308 used in the flash memory 401 illustrated in FIG. 4 according to the second embodiment. In FIG. 11, the substantially same elements as illustrated in FIG. 4 are designated by like reference numerals.

It is now assumed that the address line set 310 illustrated in FIG. 4 has 32 address lines A31 through A0 and that the data line set 311 illustrated in FIG. 4 has 16 data lines D15 through D0.

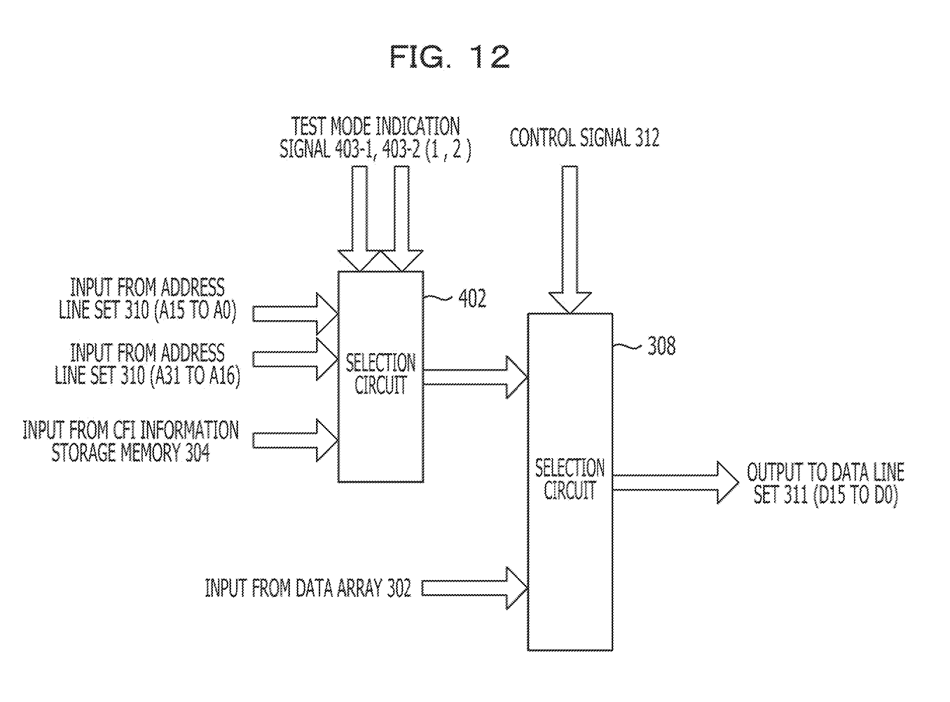

All the address lines forming the address line set 310 are connected to the input of the selection circuit 402. The selection circuit 402 selects the address values of a specific range of the address line set 310 corresponding to each test mode in accordance with the corresponding test mode indication signal 403 output from the controller 306. FIG. 12 is a block diagram illustrating a second configuration of the selection circuits 402 and 308 used in the flash memory 401 illustrated in FIG. 4 according to the second embodiment. The second configuration illustrated in FIG. 12 differs from the first configuration illustrated in FIG. 11 in that the selection circuit 402 selects one of the lower address lines A15 through A0 and the higher address lines A31 through A16 in accordance with the two test mode indication signals 403-1 and 403-2 supplied from the controller 306. With this configuration, the address values of a specific range (for example, the higher address lines or the lower address lines) forming the address line set 310 for each test mode are output from the selection circuit 402 and the selection circuit 308 to an external source via the input/output buffer 309 and the data line set 311. As a result, control processing for each of operations S502-1→S503-1, operations S502-2→S503-2, through operations S502-n→S503-n in FIG. 9 in accordance with the corresponding test modes is implemented.

According to the second embodiment illustrated in FIGS. 4 and 9 through 12, a plurality of test modes are set so that connection tests for the address values of a plurality of specific ranges are individually performed.

In the second embodiment, advantages substantially similar to those obtained by the first embodiment are offered. That is, normally, the CFI query mode is not used for purposes other than the reading of CFI information, and does not appear during the transition to another mode. Also, a writing operation during the CFI query mode is a meaningless operation. Accordingly, there is little possibility that a sequence for changing the mode to the CFI query mode for purposes other than the reading of device information or for changing the mode to the test mode in response to a writing operation, which is not accepted in the CFI query mode, is assigned to another meaning by future changes made to the common specifications. As a result, the pin compatibility of the flash memory 401 illustrated in FIG. 4 with known devices is maintained without the need to increase the number of pins for performing tests, such as terminals specially used for the boundary scan method. Additionally, a connection test for higher address lines can be performed without performing erasing or writing on the data array 302 illustrated in FIG. 4, thereby making it possible to reduce the test time compared with known test methods. Since erasing or writing on the data array 302 is not performed, loss of data due to accidents that may occur during the test is reduced. For example, loss of data saved in a space of a double data rate (DDR) memory due to the sudden power cut is avoided.

In the configuration of the controller 306 illustrated in FIG. 6 or 10 in accordance with the first or second embodiment, respectively, the time at which the command decoder 603 or 1001 resets the data retaining circuit 605 or the data retaining circuits 605-1 through 605-n to the non-test mode is the time at which the command decoder 603 or 1001 decodes a reset code input from an external source. In this case, the state of the state machine 307 is changed to the data array read mode in accordance with an operation of a standard flash memory in response to a write command.

Additionally, the command decoder 603 or 1001 may reset the data retaining circuit 605 or the data retaining circuits 605-1 through 605-n to the non-test mode at a time at which the command decoder 603 or 1001 decodes a chip select signal CS (enable) and a write enable signal WE (disable, i.e., specify a read operation) input from an external source. In this case, the state machine 307 is maintained in the CFI query mode in accordance with an operation of a standard flash memory in response to a read command. Accordingly, processing for controlling the state machine 307 to return to the CFI query mode when the test mode is canceled is implemented.

The above-described configuration may be applicable when it is desired that an operation in the test mode and reading of CFI information in the CFI query mode be alternately performed.

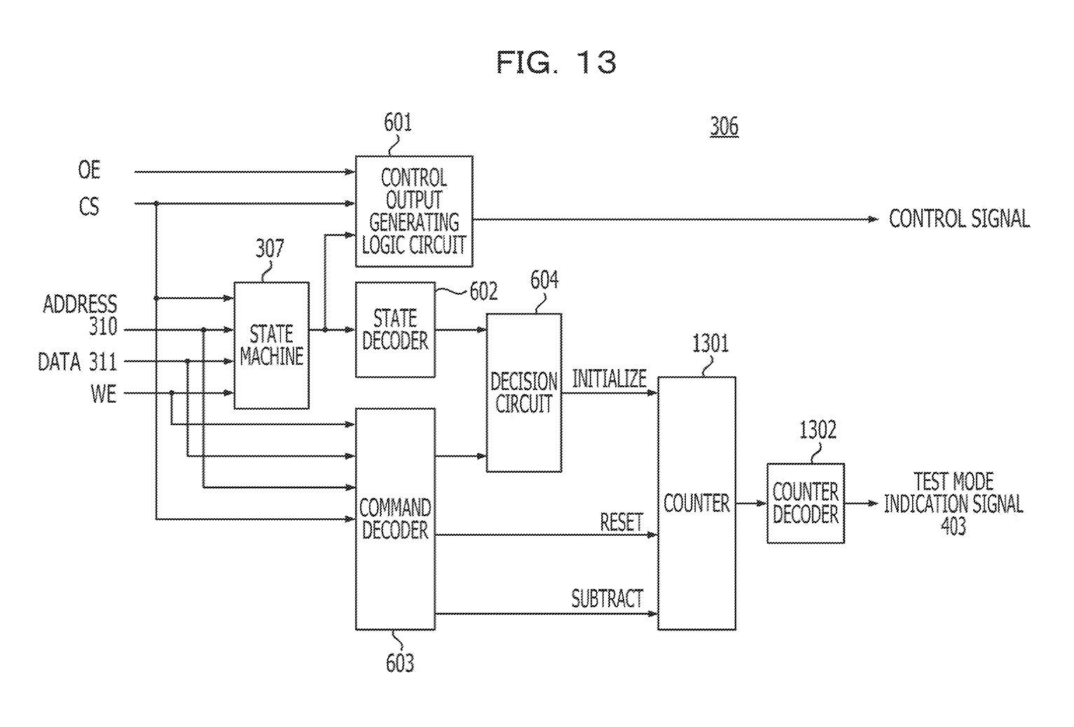

FIG. 13 is a block diagram illustrating the controller 306 used in the flash memory 401 illustrated in FIG. 4 in accordance with the third embodiment. In this configuration, the state machine 307, the control output generating logic circuit 601, the state decoder 602, the command decoder 603, and the decision circuit 604 are the same as those in FIG. 6.

In a manner substantially similar to the controller 306 configured as illustrated in FIG. 6, in response to a request to write specific data into a specific address from an external source when the state machine 307 is in the CFI query mode, the decision circuit 604 sets the test mode. In this case, the decision circuit 604 initializes a counter 1301.

When the output value of the counter 1301 is not 0, a counter decoder 1302 outputs the test mode indication signal 403 for setting the test mode to the selection circuit 402 having a configuration substantially similar to that illustrated in FIG. 7.

When the chip select signal CS indicates “enable” and when the write enable signal WE indicates “disable” (read command), the command decoder 603 subtracts the counter 1301. Accordingly, after the flash memory 401 is changed to the test mode, every time a read operation for reading a test pattern from the address line set 310 is specified, the counter 1301 is subtracted. When the read operation is specified a certain number of times, the output value of the counter 1301 reaches 0. At this time, the test mode indication signal 403 output from the counter decoder 1302 indicates the value corresponding to the non-test mode, and as a result, the test mode is canceled. In this case, the state machine 307 is maintained in the CFI query mode in accordance with an operation of a standard flash memory in response to a read command. Thus, processing for controlling the state machine 307 to return to the CFI query mode when the test mode is canceled is implemented.

In a manner substantially similar to the controller 306 illustrated in FIG. 6, when inputs from an external source are as follows: the chip select signal CS indicates “true”, the write enable signal WE indicates “true”, the address on the address line set 310 represents an arbitrary value, and the data on the data line set 311 represents a reset code, the command decoder 603 also outputs a logical value “true”. This output is supplied to the counter 1301 as a reset signal R for setting the non-test mode. With this arrangement, when a reset code is written from an external source, the counter 1301 is reset to 0 (non-test mode) regardless of the state of the state machine 307. In this case, the state of the state machine 307 is changed to the data array read mode in accordance with an operation of a standard flash memory in response to a reset request.

According to the configuration of the controller 306 of the third embodiment illustrated in FIG. 13, the following advantage is offered. When it is desired that tests be conducted on a certain number of test patterns on the address line set 310, the test mode is automatically canceled after counting a certain number of tests by the counter, thereby making it possible to change the mode to the CFI query mode.

In the first through third embodiments as described above, additional changes to the configuration of a standard flash memory are the addition of the selection circuit 402 illustrated in FIG. 4 and the feature extension of the controller 306.

When the test mode indication signal 403 indicates the test mode, the state machine 307 of the controller 306 is in the CFI query mode in accordance with an operation of a standard flash memory. In order to change the state of the state machine 307 to a mode other than the CFI query mode, the state machine 307 is shifted to the data array read mode. In order to change the mode to the data array read mode, the input of a reset code from an external source is required. In any of the controllers 306 according to the first through third embodiments, the controller 306 is changed to the non-test mode in response to a request to write a reset code. That is, during the test mode, the state machine 307 is not changed to a mode other than the CFI query mode.

The control signal 312 output from the controller 306 during the test mode indicates an operation to be performed in the CFI query mode. That is, the controller 306 executes processing so that the output from the selection circuit 402 is output to the data line set 311 in response to a read command from an external source.

During the non-test mode, the selection circuit 308 selects the input received from the CFI information storage memory 304 via the selection circuit 402, which is not the input received from the data array 302. The circuit configuration of the other elements is basically the same as that of a standard flash memory, and thus, the operation thereof is also basically the same as that of a standard flash memory.

It is thus possible to provide a flash memory that transfers the address values on the address line set 310 to the data line set 311 after changing the mode to the test mode.

In the foregoing first through third embodiments, after shifting to the test mode while maintaining the CFI query mode, the address values of the address line set 310 are output to the data line set 311 within the flash memory 401. Alternatively, using another mode other than the CFI query mode, for example, an auto select mode provided for the flash memory 401, the test mode is selected while maintaining the auto select mode, in which case, functions similar to those described above are also implemented.

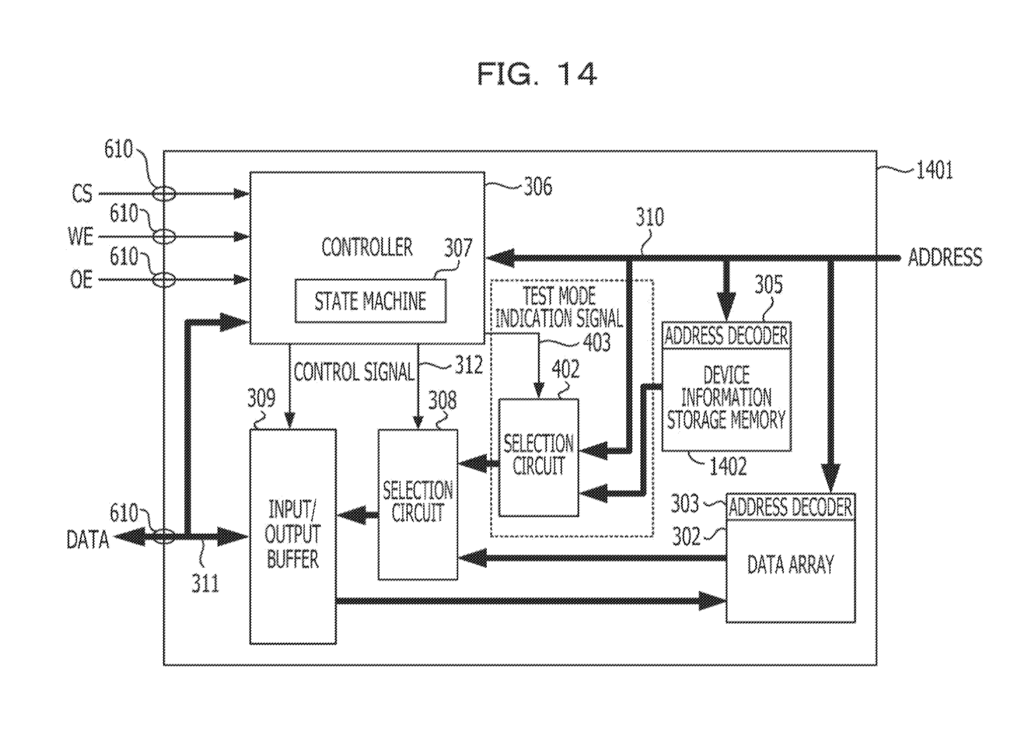

FIG. 14 is a block diagram illustrating the internal configuration of a flash memory 1401 provided with an auto select mode in accordance with a fourth embodiment. The basic configuration is substantially the same as that illustrated in FIG. 4. In the configuration illustrated in FIG. 14, the CFI information storage memory 304 illustrated in FIG. 4 is substituted for a device information storage memory 1402 for storing therein device information in the auto select mode.

Details of the elements forming the flash memory 1401 illustrated in FIG. 14 are as follows. The data array 302 stores data therein. The address decoder 303 is connected to the data array 302 and decodes an address specified from an external source via the address line set 310 to specify an address in the data array 302. The device information storage memory 1402 stores therein device information in the auto select mode. The address decoder 305 is connected to the device information storage memory 1402 and decodes an address specified from an external source via the address line set 310 to specify an address in the device information storage memory 1402. The controller 306 supplies the control signal 312 to the selection circuit 308 and the input/output buffer 309 and also supplies the test mode indication signal 403 to the selection circuit 402 on the basis of a chip select signal CS, a write enable signal WE, and an output enable signal OE supplied from an external source. The controller 306 is formed of a logic circuit and contains the state machine 307 that controls the state of the flash memory 1401. The selection circuit 308 selects an output from the data array 302 or an output from the selection circuit 402 on the basis of the control signal 312 supplied from the controller 306. When reading data, the input/output buffer 309 receives and buffers the output received from the selection circuit 308, and outputs the data or the CFI information to an external source via the data line set 311. When writing data, the input/output buffer 309 buffers data input from an external source via the data line set 311, and writes the buffered data to the data array 302. The selection circuit 402 is disposed between the device information storage memory 1402 and the selection circuit 308, and selects the output from the device information storage memory 1402 or the higher address values of the address line set 310 so as to supply the selected data to the selection circuit 308. The selection circuit 402 is controlled by the test mode indication signal 403 supplied from the controller 306.

After the flash memory 1401 is started, the state machine 307 built in the flash memory 1401 illustrated in FIG. 14 according to the fourth embodiment is operated in the data array read mode for reading data from the data array 302.

In this state, upon receiving a certain command sequence defined in the auto select mode from an external source, the state of the state machine 307 in the controller 306 is changed to the auto select mode.

In the auto select mode, an address used for the auto select mode is specified in the address line set 310, and a chip select signal CS (enable), a write enable signal WE (disable, i.e., specify a read operation), and an output enable signal OE (enable) are supplied. After that, the address decoder 305 decodes the address, and supplies the decoded address to the device information storage memory 1402. The controller 306 supplies the control signal 312 for selecting the input, which is not the input received from the data array 302, to the selection circuit 308. The controller 306 also renders the test mode indication signal 403 inactive so as to cause the selection circuit 402 to select the output from the device information storage memory 1402. As a result, the device information corresponding to the specified address read from the device information storage memory 1402 is output to an external source from the selection circuit 402 and the selection circuit 308 via the input/output buffer 309 and the data line set 311.

In this case, since the storage capacity of the device information storage memory 1402 is limited, the effective address of the address line set 310 having, for example, 25 bits, is the lower 16 bits, and the higher 9 bits are set to be 0 or the don't care state.

According to the above-described operation, by checking whether the expected device information is read from the data line set 311, a device connection test concerning specifying an address by using the lower 16 bits is conducted.

In the auto select mode, as a write command sequence for setting the reset mode defined in the auto select mode, a chip select signal CS (enable) and a write enable signal WE (enable, i.e., specify a write operation) are supplied from an external source, and the reset value is supplied to the data line set 311. The address supplied to the address line set 310 may be an arbitrary value. After that, the controller 306 decodes the above-described signals so that the state of the state machine 307 is returned to the data array read mode. In the data array read mode, the controller 306 supplies the control signal 312 for selecting the output from the data array 302 to the selection circuit 308.

In the auto select mode, a chip select signal CS (enable) and a write enable signal WE (enable, i.e., specify a write operation) are supplied to the flash memory 401 illustrated in FIG. 4 from an external source. Also, specific values other than the reset value in the auto select mode are supplied to the data line set 311 and the address line set 310. Then, the controller 306 decodes the above-described signals, and supplies the resulting test mode indication signal 403 for selecting the address values of a specific range (for example, higher bits) of the address line set 310 to the selection circuit 402. Thus, the state of the flash memory 1401 is changed to the test mode while the state of the state machine 307 is maintained in the auto select mode.

During the above-described test mode, the auto select mode is also maintained. Accordingly, during the test mode, when an instruction to perform a read operation, which is normally made in the auto select mode, is specified, the following operation is performed. An address for conducting a test operation is specified in the address line set 310, and a chip select signal CS (enable), a write enable signal WE (disable, specify a read operation), and an output enable signal OE (enable) are supplied from an external source. As a result, the controller 306 supplies the control signal 312 for selecting the output from the selection circuit 402, which is not the input from the data array 302, to the selection circuit 308. As stated above, in the test mode, the selection circuit 402 selects the address values of a specific range (for example, higher bits) of the address line set 310. As a result, the address values of a specific range (for example, higher bits) of the address line set 310 are output from the selection circuit 402 and the selection circuit 308 to an external source via the input/output buffer 309 and the data line set 311.

According to the foregoing read operation, in the test mode while maintaining the auto select mode, a check of whether the address values of a specific range (higher bits) specified in the address line set 310 are read from the data line set 311 is performed. As a result, a device connection test can be performed to check whether the address values of the above-described specific range (higher bits) are correctly specified.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

Advantages

According to the configuration and method of the foregoing embodiments, a test for flash memory devices, for example, a connection test for higher address lines, is correctly performed while maintaining pin compatibility with standard devices or without changing standard specifications.

What is claimed is:

1. A flash memory comprising a controller,
the controller including:
a state machine;
a state decoder that determines whether a state of the state machine is in a specified mode;
a command decoder that determines whether an input signal received through an external pin specifies a write operation for writing a specific value into a specific address; and
a test mode setting circuit that sets a test mode while the specified mode is maintained when the state decoder determines that the state of the state machine is in the specified mode and when the command decoder determines that the input signal received through the external pin specifies a write operation for writing a specific value into a specific address.

2. The flash memory according to claim 1, wherein:
the flash memory complies with a specification of a common flash memory interface;
the state decoder detects a state of the flash memory, the state including a state indicating whether the flash memory is in a query mode in the common flash memory interface; and
the test mode setting circuit includes
a decision circuit that receives an output from the command decoder and an output from the state decoder and determines that the flash memory is in the test mode when the state decoder determines that the flash memory is in the query mode and when the command decoder determines that the input signal received through the external pin specifies a write operation for writing a specific value into a specific address, and
a data retaining circuit that sets a decision output signal output from the decision circuit and retains therein a test mode signal indicating that the flash memory is set in the test mode.

3. The flash memory according to claim 2, further comprising:
a memory that stores therein information concerning the common flash memory interface; and
a first selection circuit that inputs an output from the test mode setting circuit into a control input terminal, and that inputs the information concerning the common flash memory interface output from the memory into a first input terminal and inputs information concerning higher address values of address lines into a second input terminal, and that, when the output from the test mode setting circuit input into the control input terminal does not indicate the test mode, the first selection circuit outputs the information concerning the common flash memory interface to data lines representing data concerning the flash memory, and that, when the output from the test mode setting circuit input into the control input terminal indicates the test mode, the first selection circuit outputs the information concerning the higher address values of the address lines to the data lines.

4. The flash memory according to claim 3, further comprising:
a data array; and
a second selection circuit including a control input terminal that receives a control signal from the controller, a first input terminal to which an output from the first selection circuit is supplied, and a second input terminal to which an output from the data array is supplied, the second selection circuit selecting the output from the first selection circuit or the output from the data array in accordance with the control signal.

5. The flash memory according to claim 3, wherein, when an input supplied to the control input terminal indicates a first test mode, the first selection circuit outputs the information concerning the higher address values of the address lines, which is specified in the address lines in response to a read command sequence and which is to be input into the second input terminal, to the data lines, and, when the input supplied to the control input terminal indicates a second test mode, the first selection circuit outputs information concerning lower address values of the address lines, which is specified in the address lines in response to the read command sequence and which is to be input into the second input terminal, to the data lines.

6. The flash memory according to claim 2, wherein:
the test mode includes a plurality of test modes;
the decision circuit determines whether the state decoder has detected that the flash memory is in the query mode and whether the command decoder has detected a plurality of write command sequences other than a write command sequence for resetting the query mode; and
the data retaining circuit outputs the test mode signal indicating one of the plurality of test modes which is set in association with the decision output signal output from the decision circuit.

7. The flash memory according to claim 2, wherein, when the command decoder detects a write command sequence for resetting the query mode, the data retaining circuit is reset so as to cancel the test mode indicated by the test mode signal.

8. The flash memory according to claim 2, wherein, when the test mode signal is output, the data retaining circuit is reset every time address information concerning a test result for a read command sequence is output and cancels the test mode.

9. The flash memory according to claim 2, wherein the data retaining circuit is a counter circuit that counts a number of read command sequences detected by the command decoder after setting the decision output signal output from the decision circuit, and that continues to output the test mode signal until the number of counted read command sequences reaches a specified number after setting the decision output signal output from the decision circuit, and that is reset when the number of counted read command sequences reaches the specified number, so that the test mode is maintained while address information concerning a test result is output a specified number of times.

10. The flash memory according to claim 1, wherein:
the flash memory complies with specifications of an auto select mode;
the state decoder detects a state of the flash memory, the state including a state indicating whether the flash memory is in an auto select mode; and
the test mode setting circuit includes
a decision circuit that receives an output from the command decoder and an output from the state decoder and determines that the flash memory is in the test mode when the state decoder determines that the flash memory is in the auto select mode and when the command decoder determines that the input signal received through the external pin specifies a write operation for writing a specific value into a specific address, and
a data retaining circuit that sets a decision output signal output from the decision circuit and retains therein a test mode signal indicating that the flash memory is set in the test mode.

11. A connection test method for a flash memory, the method comprising:
determining whether a state of the flash memory is in the specified mode; and
determining whether an input signal received through an external pin specifies a write operation for writing a specific value into a specific address; and
setting a test mode while the specified mode is maintained when the state of the flash memory is in the specified mode and when the input signal specifies a write operation for writing a specific value into a specific address.

12. The connection test method according to claim 11, wherein, when the test mode is not set, information concerning a common flash memory interface is output to data lines of the flash memory, and when the test mode is set, information concerning address values of address lines of the flash memory is output to the data lines.

13. A flash memory comprising a controller,
the controller including:
a determining mechanism to determine whether a state of the flash memory is in a specified mode;
a detecting mechanism to detect a specified command sequence which is not defined by the specified mode; and
a setting mechanism to set a mode which is not defined by the specified mode while the specified mode is maintained when the state of the flash memory is in the specified mode and when the specified command sequence is detected.

14. A connection test method for the flash memory according to claim 13, wherein:
the specified mode is a query mode in a common flash memory interface;
the mode which is not defined by the specified mode is a test mode; and
the flash memory further includes a selection circuit that inputs a signal indicating the test mode into a control input terminal, and that inputs information concerning the common flash memory interface into a first input terminal and inputs information concerning higher address values of address lines into a second input terminal, and that when the signal input into the control input terminal does not indicate the test mode, the information concerning the common flash memory interface is output to data lines of the flash memory, and that when the signal input into the control input terminal indicates the test mode, the information concerning the higher address values of the address lines is output to the data lines.
